(19) United States
(12) Patent Application Publication
(10) Pub. No.: US 2026/0163114 A1
(43) Pub. Date: Jun. 11, 2026

(54) BATTERY PACK AND VEHICLE

(71) Applicant: HONDA MOTOR CO., LTD., Tokyo (JP)

(72) Inventors: Takahiro KOSHINO, Tokyo (JP); Hiroki SAKAMOTO, Tokyo (JP); Satoshi MORIYAMA, Tokyo (JP); Ryosuke NAKAZATO, Tokyo (JP); Motoi SHIOAKU, Tokyo (JP)

(73) Assignee: HONDA MOTOR CO., LTD., Tokyo (JP)

(21) Appl. No.: 19/412,894

(22) Filed: Dec. 9, 2025

(30) Foreign Application Priority Data
Dec. 11, 2024 (JP) 2024-216544

(51) Int. Cl. H01M 10/6561; B60K 1/04; B60L 50/64; H01M 10/613; H01M 10/625; H01M 50/249; H01M 50/271

(52) U.S. Cl. CPC H01M 10/6561; B60K 1/04; B60L 50/64; H01M 10/613; H01M 10/625; H01M 50/249; H01M 50/271; B60K 2001/0438; H01M 2220/20

(57) ABSTRACT

A battery pack includes: a battery; and a case accommodating the battery, a top plate portion of the case has an outside air introduction port opened upward, the battery pack includes a cover member covering the outside air introduction port from an upper side, the cover member includes a side wall surrounding the outside air introduction port and having an air intake port communicating with the outside air introduction port, and an eaves wall protruding from the side wall in an opening direction of the air intake port and provided above the air intake port, a tip end of the eaves wall is located farther than a distal end of the air intake port when viewed from a central axis of the outside air introduction port, and the distal end is a portion of the air intake port farthest from the central axis of the outside air introduction port.

### CROSS-REFERENCE TO RELATED APPLICATION

This application is based on and claims priority under 35 USC 119 from Japanese Patent Application No. 2024-216544 filed on Dec. 11, 2024.

### TECHNICAL FIELD

The present invention relates to a battery pack and a vehicle equipped with the battery pack.

### BACKGROUND ART

In recent years, researches and developments have been conducted on a secondary battery which contributes to improvement in energy efficiency in order to allow more people to have access to affordable, reliable, sustainable and advanced energy.

A case structure of a power equipment unit described in Patent Literature 1 includes a lid member that covers an upper portion of a case body that accommodates power equipment such as a battery for driving a vehicle, and a cover member that covers an opening portion of the lid member, and an air intake port for taking in air from the outside is provided in a side wall of the cover member surrounding the opening portion. In order to prevent foreign matter or the like, which enters from the air intake port, from entering an inisde of a case through the opening portion, a partition member extending downward from an upper wall of the cover member is provided between the air intake port and the opening portion and a passage reaching the opening portion from the air intake port has a labyrinth shape.

An air intake structure for a vehicle electric device described in Patent Literature 2 includes an upper lid provided with an air intake fan that supplies cooling air to an electric device such as a DC/DC converter, and a cover member that covers the upper lid from above, and an air intake port is provided in a top surface portion of the cover member. An upper end of the air intake fan is located at a position higher than an upper surface of the upper lid, the air intake port is provided in a region of the cover member away from the air intake fan, and a passage reaching the air intake fan from the air intake port has a labyrinth shape.
Patent Literature 1: JP2017-165231A
Patent Literature 2: JP2020-172224A

### SUMMARY OF INVENTION

A flow path for outside air that is intricate in a labyrinth shape as described in Patent Literature 1 and Patent Literature 2 is useful from a viewpoint of preventing the foreign matter from entering an inside of the case, but on the other hand, can be a cause of increasing a flow path resistance. An object of the present invention is to prevent foreign matter from entering an inside of a case, simplify a flow path reaching the inside of the case from an air intake port, and to smooth an air flow.

An aspect of the present invention is a battery pack including:
a battery; and
a case accommodating the battery, in which
a top plate portion of the case is provided with an outside air introduction port that is opened upward,
the battery pack further includes a cover member covering the outside air introduction port from an upper side,
the cover member includes
   a side wall that surrounds the outside air introduction port and is provided with an air intake port communicating with the outside air introduction port, and
   an eaves wall that protrudes from the side wall in an opening direction of the air intake port and is provided above the air intake port, and
a tip end of the eaves wall is located farther than a distal end of the air intake port when viewed from a central axis of the outside air introduction port.

Another aspect of the present invention is a vehicle including:
the above battery pack; and
a drive source configured to receive power supply from the battery pack, in which
the battery pack is installed between a floor panel and a seat of the vehicle.

According to the present invention, foreign matter can be prevented from entering an inside of the case. Accordingly, a flow path reaching the inside of the case from the air intake port can be simplified, and an air flow can be smoothed.

### BRIEF DESCRIPTION OF DRAWINGS

FIG. 1 is a schematic diagram of an example of a vehicle for illustrating an embodiment of the present invention.

FIG. 2 is a schematic diagram showing a positional relationship between a battery pack and a seat in the vehicle of FIG. 1.

FIG. 3 is a schematic diagram showing the positional relationship between the battery pack and the seat in the vehicle of FIG. 1.

FIG. 4 is an exploded perspective view of the battery pack mounted on the vehicle of FIG. 1.

FIG. 5 is a cross-sectional view of the battery pack of FIG. 4.

FIG. 6 is a cross-sectional view of a cover member of the battery pack of FIG. 4.

FIG. 7 is a plan view of a top plate portion of a case of the battery pack of FIG. 4.

FIG. 8 is a schematic diagram showing air flows in the battery pack of FIG. 4.

FIG. 9 is a cross-sectional view of a modification of the cover member of the battery pack of FIG. 4.

FIG. 10 is a cross-sectional view of another modification of the cover member of the battery pack of FIG. 4.

### DESCRIPTION OF EMBODIMENTS

An example of a vehicle for illustrating an embodiment of the present invention will be described with reference to the accompanying drawings. The drawings are viewed from directions of reference numerals. In the present specification and the like, in order to simplify and clarify the description, a front-rear direction, a left-right direction, and an upper-lower direction are described according to a direction viewed from a driver of a vehicle, and in the drawings, a front side of the vehicle is shown as Fr, a rear side is shown as Rr, a left side is shown as L, a right side is shown as R, an upper side is shown as U, and a lower side is shown as D.

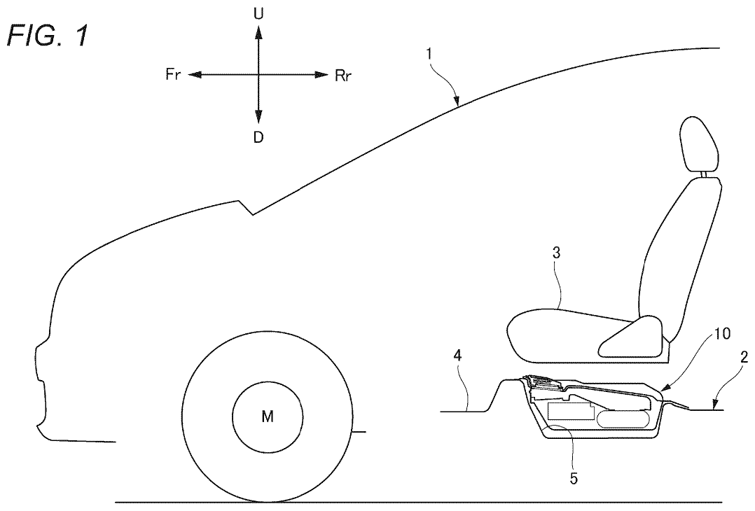

A vehicle 1 shown in FIG. 1 is an electric vehicle such as a battery electric automobile, a hybrid vehicle (including a plug-in hybrid vehicle), or a fuel cell vehicle. The vehicle 1 includes a vehicle body 2, a seat 3, and a battery pack 10. The vehicle body 2 constitutes a framework of the vehicle 1, and the battery pack 10 stores and discharges electric power to be supplied to a motor M or the like serving as a drive source of the vehicle.

The vehicle body 2 includes a floor panel 4. The floor panel 4 constitutes a part of a framework of a vehicle lower part. Although not shown, the vehicle body 2 may include, as members constituting the framework of the vehicle lower part, a pair of side sills extending in a vehicle front-rear direction along both side portions of the floor panel 4, a cross member bridged between the pair of side sills, and the like. The seat 3 is installed on the floor panel 4 and is configured to be movable in the vehicle front-rear direction.

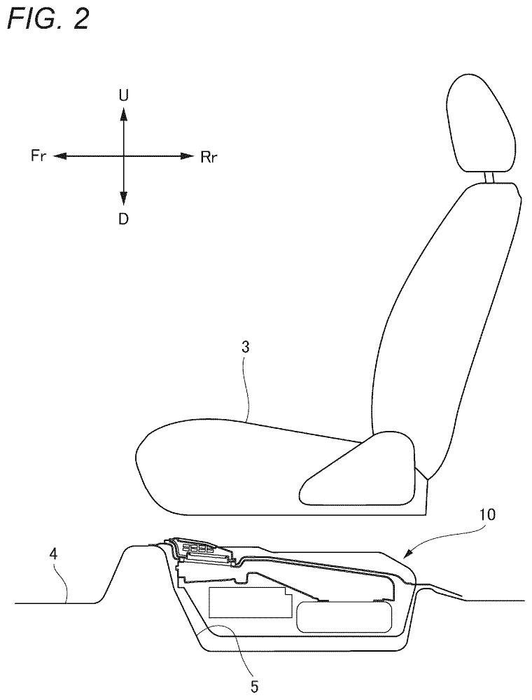

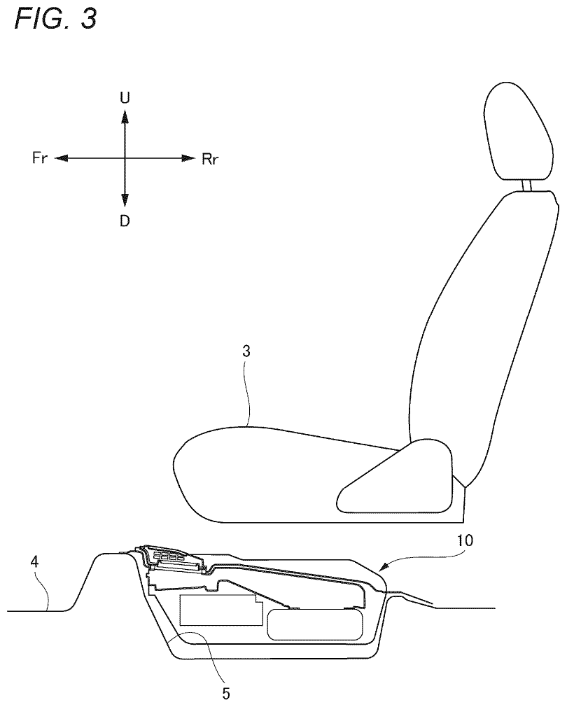

The battery pack 10 is also installed on the floor panel 4, and is located below the seat 3 in the example shown in FIG. 1. A recessed portion 5 is formed in the floor panel 4, and the battery pack 10 is accommodated in the recessed portion 5. An interior space of the vehicle 1 can be enlarged by accommodating the battery pack 10 in a space under the seat that is a dead space. FIGS. 2 and 3 show a positional relationship between the battery pack 10 and the seat 3, FIG. 2 shows a state where the seat 3 that is movable forward and rearward is disposed at a most forward position, and FIG. 3 shows a state where the seat 3 is disposed at a most rearward position. The battery pack 10 is covered by the seat 3 in a state where the seat 3 is disposed at the most forward position. Meanwhile, in a state where the seat 3 is disposed at the most rearward position, a front portion of the battery pack 10 is exposed from the seat 3. Basically, the battery pack 10 is preferably covered by the seat 3 regardless of the forward and backward movement of the seat 3, but a part of the battery pack 10 may be exposed from the seat 3 as shown in FIG. 3, for example, depending on installation conditions of the seat 3 and the battery pack 10, a movement amount of the seat 3, and the like.

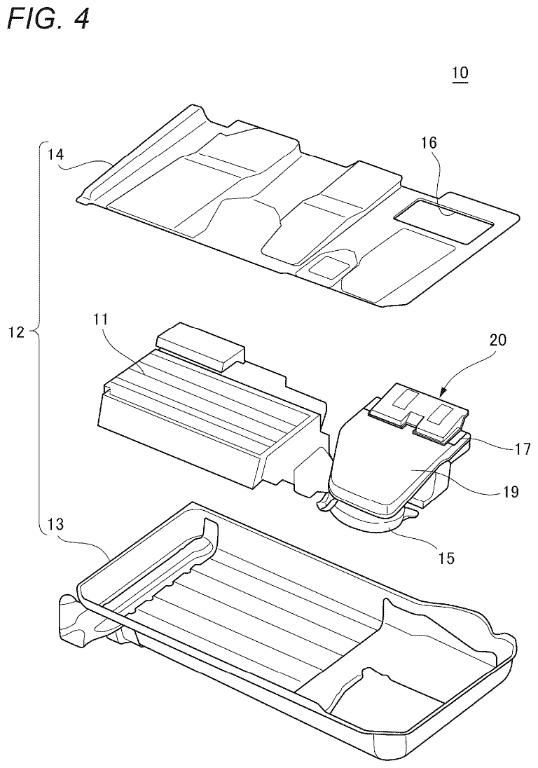

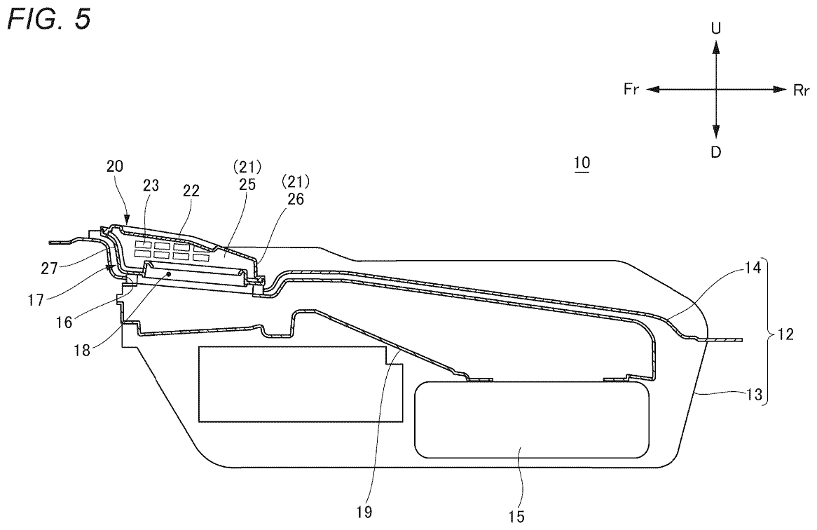

As shown in FIGS. 4 and 5, the battery pack 10 includes batteries 11 and a case 12 that accommodates the batteries 11. Each of the batteries 11 includes a plurality of battery cells. The battery cell is, for example, a lithium-ion battery or nickel-hydrogen battery using a liquid electrolyte, or an all-solid-state battery using a solid electrolyte. The battery 11 is typically modularized in a state where the plurality of battery cells are connected in series and/or in parallel.

The case 12 includes a case body 13 and a case cover 14. The case body 13 is formed in a tray shape capable of accommodating the batteries 11. The case body 13 is, for example, formed by a plate member made of metal such as an aluminum alloy or steel. The case cover 14 covers the case body 13 from above.

The case 12 further accommodates electrical devices such as an air intake fan 15, a junction box, and a bus bar. The junction box controls a connection between a charging system mounted on the vehicle and the battery pack 10, and a connection between an inverter that drives the motor M and the battery pack 10. The bus bar connects the modularized batteries 11 to each other, and connects the batteries 11 and the junction box. The air intake fan 15 introduces outside air for cooling the batteries 11 and the electrical devices into the case 12.

An opening 16 is provided in the case cover 14, and an attachment 17 is attached to cover the opening 16 from above. A top plate portion of the case 12 is formed by the case cover 14 and the attachment 17, and the attachment 17 is provided with outside air introduction ports 18 communicating with an inside of the case 12. The outside air introduction ports 18 are provided in a front portion of the top plate portion of the case 12, and the front portion of the top plate portion of the case 12 is a portion exposed from the seat 3 in a state where the seat 3 is disposed at the most rearward position. The case cover 14 and the attachment 17 may be formed as one member.

The battery pack 10 further includes cover members 20 that cover the outside air introduction ports 18 from above. Each of the cover members 20 includes a side wall 21 surrounding the corresponding outside air introduction port 18 and a ceiling wall 22. The side wall 21 is provided with an air intake port 23 communicating with the outside air introduction port 18. Outside air sucked from the air intake port 23 flows into a duct 19 through the outside air introduction port 18, and is guided to the air intake fan 15 by the duct 19.

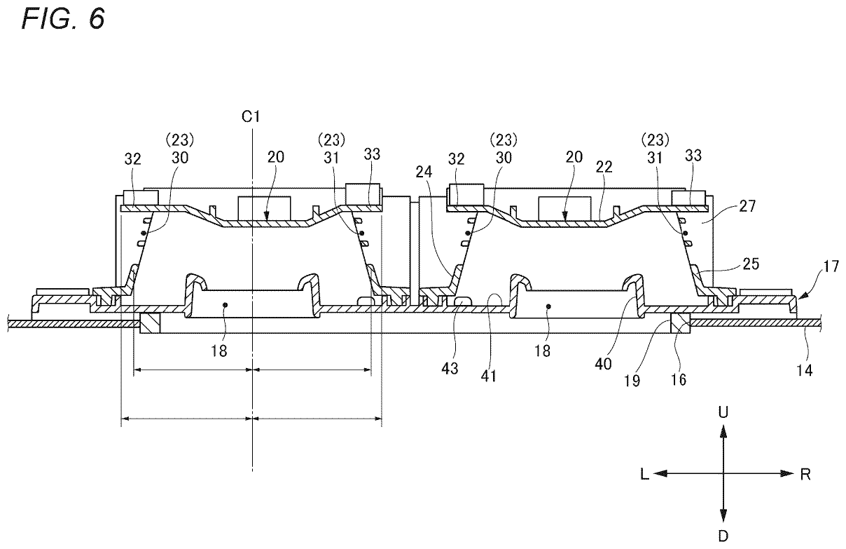

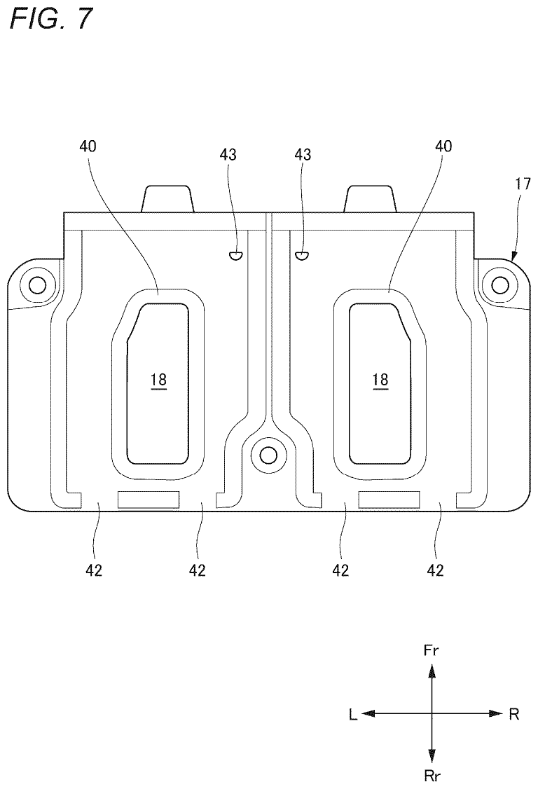

FIGS. 6 and 7 show a configuration example around the outside air introduction ports 18 and the air intake ports 23. In the example shown in FIGS. 6 and 7, the attachment 17 is provided with two outside air introduction ports 18 spaced apart from each other in a vehicle width direction. Then, two cover members 20 provided for the respective outside air introduction ports 18 are attached to the attachment 17.

The side wall 21 of the cover member 20 includes a left wall 24 and a right wall 25 facing each other in the vehicle width direction to sandwich the outside air introduction port 18, and a rear wall 26 (see FIG. 5) disposed behind the outside air introduction port 18. A front wall 27 surrounding the outside air introduction port 18 together with the left wall 24, the right wall 25, and the rear wall 26 extends from the attachment 17, but may be provided on the cover member 20.

Each of the left wall 24 and the right wall 25 is inclined to approach a central axis C1 of the outside air introduction port 18 from a lower end toward an upper end. The air intake port 23 includes a first air intake port 30 provided in the left wall 24 and a second air intake port 31 provided in the right wall 25. Each of the first air intake port 30 and the second air intake port 31 is provided with a grid that partitions an opening vertically and horizontally, and the grid prevents foreign matter from the outside entering an inside of the cover member 20.

The cover member 20 further includes a first eaves wall 32 and a second eaves wall 33. The first eaves wall 32 protrudes from the left wall 24 in an opening direction of the first air intake port 30 (leftward) above the first air intake port 30. The second eaves wall 33 protrudes from the right wall 25 in an opening direction (rightward) of the second air intake port 31 above the second air intake port 31. In the example shown in FIGS. 6 and 9, the ceiling wall 22 extends to the left and right, and the first eaves wall 32 and the second eaves wall 33 are constituted by extension portions of the ceiling wall 22, but the first eaves wall 32 and the second eaves wall 33 may be constituted separately from the ceiling wall 22.

As described above, the left wall 24 and the right wall 25 are inclined to approach the central axis C1 of the outside air introduction port 18 from the lower end toward the upper end. Therefore, a lower end of the first air intake port 30 provided in the left wall 24 is located farthest from the central axis C1. When viewed from the central axis C1, a tip end of the first eaves wall 32 is located farther than a distal end (lower end) of the first air intake port 30. Similarly, a lower end of the second air intake port 31 provided in the right wall 25 is located farthest from the central axis C1, and when viewed from the central axis C1, a tip end of the second eaves wall 33 is located farther than a distal end (lower end) of the second air intake port 31.

When a small stone, a liquid such as a beverage, or the like adhering to a shoe sole of an occupant falls onto the floor, the battery pack 10 installed on the floor panel 4 may be exposed to the foreign matter. However, since the tip end of the first eaves wall 32 is located farther than the distal end of the first air intake port 30 and the tip end of the second eaves wall 33 is located farther than the distal end of the second air intake port 31, the first air intake port 30 and the second air intake port 31 are shielded from above by the first eaves wall 32 and the second eaves wall 33. Accordingly, the foreign matter falling on the floor can be prevented from entering the inside of the case 12 through the first air intake port 30 and the second air intake port 31.

Further, there is also a possibility that foreign matter moves on the floor in the vehicle front-rear direction due to forward tilting or rearward tilting, or acceleration or deceleration of the vehicle 1. However, the first air intake port 30 and the second air intake port 31 are provided in the left wall 24 and the right wall 25 of the cover member 20 and are opened in the vehicle width direction. Accordingly, the foreign matter moving on the floor in the vehicle front-rear direction can be prevented from entering the inside of the case 12 through the first air intake port 30 and the second air intake port 31.

Further, the battery pack 10 is disposed below the seat 3 that is movable forward and backward, and as shown in FIG. 3, the cover member 20 disposed at the front portion of the battery pack 10 is exposed when the seat 3 is moved most rearward. However, since the first air intake port 30 and the second air intake port 31 are shielded from above by the first eaves wall 32 and the second eaves wall 33, the inside of the case 12 can be prevented from being visually recognized through the first air intake port 30 and the second air intake port 31.

In particular, since the first air intake port 30 and the second air intake port 31 are provided in the left wall 24 and the right wall 25 of the cover member 20 instead of the front wall 27 that is likely to be looked into by the occupant, the inside of the case 12 can be more reliably prevented from being visually recognized through the first air intake port 30 and the second air intake port 31.

From a viewpoint of preventing the foreign matter from entering the inside of the case 12, the attachment 17 includes a tubular portion 40 extending upward from an edge of the outside air introduction port 18. A recessed portion 41 is formed between the left wall 24, the right wall 25, the rear wall 26, and the front wall 27, which surround the tubular portion 40 and the tubular portion 40. Even if the foreign matter enters the inside of the cover member 20 through the first air intake port 30 and the second air intake port 31, the foreign matter is accumulated in the recessed portion 41. Accordingly, the foreign matter can be more reliably prevented from entering the inside of the case 12.

The foreign matter accumulated in the recessed portion 41 is discharged from a discharge port provided in the attachment 17 or the side wall 21 of the cover member 20. At least one discharge port may be provided, and in the example shown in FIGS. 6 and 7, the discharge port is provided in, among the left wall 24, the right wall 25, the rear wall 26, and the front wall 27 which surround the tubular portion 40, each of the rear wall 26 and the front wall 27 facing each other to sandwich the tubular portion 40 in the vehicle front-rear direction. The foreign matter accumulated in the recessed portion 41 is discharged through first discharge ports 42 provided in the rear wall 26, for example, when the vehicle 1 is tilted rearward or accelerated. The foreign matter accumulated in the recessed portion 41 is discharged through a second discharge port 43 provided in the front wall 27, for example, when the vehicle 1 is tilted forward or decelerated.

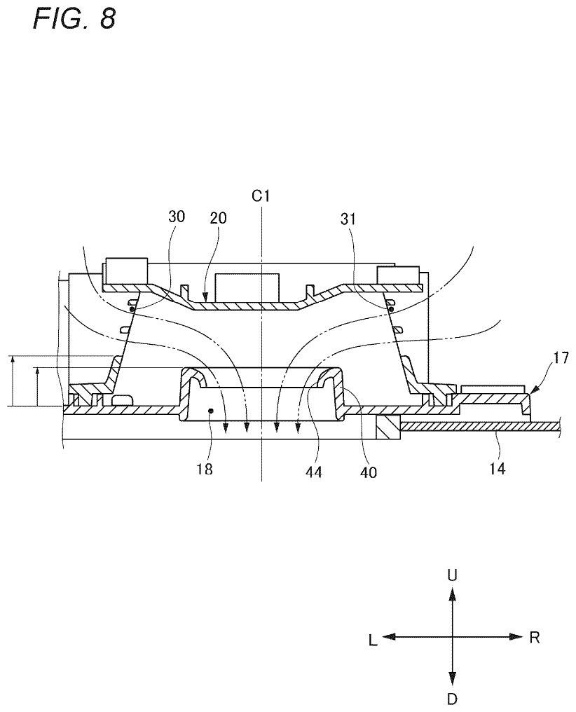

FIG. 8 shows air flows flowing into the outside air introduction port 18 through the first air intake port 30 and the second air intake port 31. As described above, since the first eaves wall 32 and the second eaves wall 33 prevent the foreign matter from entering the inside of the case 12 through the first air intake port 30 and the second air intake port 31, and prevent the inside of the case 12 from being visually recognized, flow paths of the outside air reaching the outside air introduction port 18 from the first air intake port 30 and the second air intake port 31 can be simplified.

Therefore, in an example shown in FIG. 8, a partition wall that shields, from the first air intake port 30 and the second air intake port 31, an upper end opening of the tubular portion 40 communicating with the outside air introduction port 18 is not provided. That is, the upper end opening of the tubular portion 40 is exposed when viewed from the first air intake port 30 and the second air intake port 31. Accordingly, the air flows flowing into the outside air introduction port 18 through the first air intake port 30 and the second air intake port 31 can be smoothed, an amount of the outside air introduced into the inside of the case 12 can be increased, and an efficiency of cooling the batteries 11 and the electrical devices can be increased.

Preferably, an upper end of the tubular portion 40 is located lower than the lower ends of the first air intake port 30 and the second air intake port 31. Accordingly, the outside air flowing in from lower portions of the first air intake port 30 and the second air intake port 31 can be prevented from colliding with an outer peripheral surface of the tubular portion 40, and occurrence of turbulence in the air flows can be prevented.

Preferably, the tubular portion 40 has a funnel shape that gradually approaches the central axis C1 of the outside air introduction port 18 from the upper end to a lower end of the tubular portion 40. Accordingly, the air flows flowing into the outside air introduction port 18 through the upper end opening of the tubular portion 40 can be rectified, and the amount of the outside air introduced into the inside of the case 12 can be further increased. In the example shown in FIG. 8, the tubular portion 40 has, inside the tubular portion 40, an annular extending portion 44 extending downward from the upper end of the tubular portion 40, and the extending portion 44 is formed in a funnel shape. A thickness of the tubular portion 40 may be gradually increased from the upper end toward the lower end of the tubular portion 40, and the entire tubular portion 40 has a funnel shape.

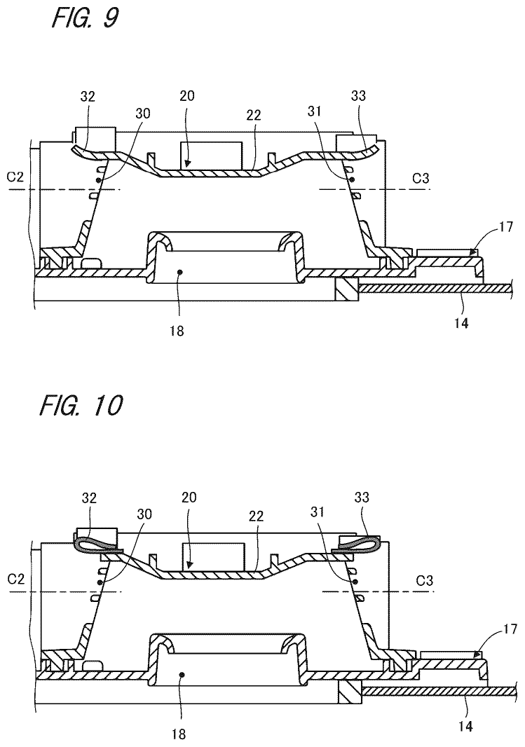

FIGS. 9 and 10 show modifications of the cover member 20, and the first eaves wall 32 has a funnel shape that gradually approaches a central axis C2 of the first air intake port 30 from a tip end toward a base end thereof. Similarly, the second eaves wall 33 has a funnel shape that gradually approaches a central axis C3 of the second air intake port 31 from a tip end toward a base end thereof. Accordingly, the air flows flowing into the outside air introduction port 18 through the first air intake port 30 and the second air intake port 31 can be rectified, and the amount of the outside air introduced into the inside of the case 12 can be further increased.

In an example shown in FIG. 9, the ceiling wall 22 of the cover member 20 extends to the left and right, and the first eaves wall 32 and the second eaves wall 33 are constituted by the extending portions of the ceiling wall 22. Meanwhile, in an example shown in FIG. 10, the first eaves wall 32 and the second eaves wall 33 are each formed of a flexible sheet material such as felt, and are joined to the ceiling wall 22 by an appropriate method such as adhesion.

In the present description, at least the following matters are described.
(1) A battery pack (battery pack 10) including:
a battery (battery 11); and
a case (case 12) accommodating the battery, in which
a top plate portion of the case is provided with an outside air introduction port (outside air introduction port 18) that is opened upward,
the battery pack further includes a cover member (cover member 20) covering the outside air introduction port from an upper side,
the cover member includes
   a side wall (side wall 21) that surrounds the outside air introduction port and is provided with an air intake port (first air intake port 30, second air intake port 31) communicating with the outside air introduction port, and
   an eaves wall (first eaves wall 32, second eaves wall 33) that protrudes from the side wall in an opening direction of the air intake port and is provided above the air intake port, and
a tip end of the eaves wall is located farther than a distal end of the air intake port when viewed from a central axis (central axis C1) of the outside air introduction port.

According to the battery pack of the above (1), the air intake port is shielded from above by the eaves wall. Accordingly, foreign matter can be prevented from entering an inside of the case through the air intake port, and the inside of the case can be prevented from being visually recognized through the air intake port.
(2) The battery pack according to the above (1), in which
the outside air introduction port is exposed when viewed from the air intake port.

According to the battery pack of the above (2), an air flow flowing into the outside air introduction port through the air intake port can be smoothed, an amount of outside air introduced into the inside of the case can be increased, and an efficiency of cooling the battery can be increased.
(3) The battery pack according to the above (1), in which
the air intake port includes a first air intake port (first air intake port 30) and a second air intake port (second air intake port 31), and
the first air intake port and the second air intake port are provided in the side wall of the cover member to sandwich the outside air introduction port.

According to the battery pack of the above (3), the amount of outside air introduced into the inside of the case can be increased, and the efficiency of cooling the battery can be increased.
(4) The battery pack according to the above (1), in which
the eaves wall has a funnel shape that gradually approaches a central axis (central axes C2 and C3) of the air intake port from the tip end toward a base end of the eaves wall.

According to the battery pack of the above (4), the air flow flowing into the outside air introduction port through the air intake port can be rectified, and the amount of outside air introduced into the inside of the case can be further increased.
(5) The battery pack according to the above (1), in which
the top plate portion of the case includes a tubular portion (tubular portion 40) extending upward from an edge of the outside air introduction port, and
an upper end of the tubular portion is located lower than a lower end of the air intake port.

According to the battery pack of the above (5), collision of the outside air flowing in from the lower portion of the air intake port with an outer peripheral surface of the tubular portion can be avoided, and occurrence of turbulence in the air flow can be prevented.
(6) The battery pack according to the above (5), in which
the tubular portion of the case has a funnel shape that gradually approaches the central axis of the outside air introduction port from the upper end toward a lower end of the tubular portion.

According to the battery pack of the above (6), the air flows flowing into the outside air introduction port through an upper end opening of the tubular portion can be rectified, and the amount of outside air introduced into the inside of the case can be further increased.
(7) The battery pack according to the above (5), in which
the top plate portion of the case and the side wall of the cover member form a recessed portion (recessed portion 41) between the tubular portion of the case and the side wall of the cover member.

According to the battery pack of the above (7), even if the foreign matter enters an inside of the cover member through the air intake port, the foreign matter can be accumulated in the recessed portion, and the foreign matter can be more reliably prevented from entering the inside of the case.
(8) The battery pack according to the above (7), in which
the top plate portion of the case or the side wall of the cover member is provided with a discharge port (first discharge port 42, second discharge port 43) leading to an outside of the case from the recessed portion.

According to the battery pack of the above (8), the foreign matter accumulated in the recessed portion can be discharged.
(9) The battery pack according to the above (8), in which
the air intake port includes a first air intake port (first air intake port 30) and a second air intake port (second air intake port 31),
the first air intake port and the second air intake port are provided in the side wall of the cover member to sandwich the outside air introduction port in a first direction (vehicle width direction),
the discharge port includes a first discharge port and a second discharge port, and
the first discharge port and the second discharge port are provided to sandwich the outside air introduction port in a second direction (vehicle front-rear direction) orthogonal to the first direction.

According to the battery pack of the above (9), the foreign matter accumulated in the recessed portion can be more reliably discharged.
(10) A vehicle including:
the battery pack according to any one of the above (1) to (9); and
a drive source (motor M) configured to receive power supply from the battery pack, in which
the battery pack is installed between a floor panel (floor panel 4) and a seat (seat 3) of the vehicle.

According to the vehicle of the above (10), an interior space of the vehicle can be enlarged by accommodating the battery pack in a space under the seat that is a dead space.
(11) The vehicle according to the above (10), in which
the battery pack is installed such that the opening direction of the air intake port is a vehicle width direction.

According to the vehicle of the above (11), the foreign matter can be more reliably prevented from entering the inside of the case through the air intake port, and the inside of the case can be more reliably prevented from being visually recognized through the air intake port.
(12) The vehicle according to the above (11), in which
the seat is movable in a vehicle front-rear direction, and
in a state where the seat is disposed at a most rearward position, at least a part of the cover member of the battery pack is exposed from the seat.

According to the vehicle of the above (12), even if the cover member is exposed from the seat, since the air intake port of the cover member is shielded from above by the eaves wall, the foreign matter can be prevented from entering the inside of the case through the air intake port, and the inside of the case can be prevented from being visually recognized through the air intake port.

### REFERENCE SIGNS LIST

1 vehicle
2 vehicle body
3 seat
4 floor panel
5 recessed portion
10 battery pack
11 battery
12 case
13 case body
14 case cover
15 air intake fan
16 opening
17 attachment
18 outside air introduction port
19 duct
20 cover member
21 side wall
22 ceiling wall
23 air intake port
24 left wall
25 right wall
26 rear wall
27 front wall
30 first air intake port
31 second air intake port
32 first eaves wall
33 second eaves wall
40 tubular portion
41 recessed portion
42 first discharge port
43 second discharge port
44 extending portion
C1 central axis
C2 central axis
C3 central axis
M motor

What is claimed is:

1. A battery pack comprising:
a battery; and
a case accommodating the battery, wherein
a top plate portion of the case is provided with an outside air introduction port that is opened upward,
the battery pack further comprises a cover member covering the outside air introduction port from an upper side,
the cover member includes
a side wall that surrounds the outside air introduction port and is provided with an air intake port communicating with the outside air introduction port, and
an eaves wall that protrudes from the side wall in an opening direction of the air intake port and is provided above the air intake port, and
a tip end of the eaves wall is located farther than a distal end of the air intake port when viewed from a central axis of the outside air introduction port, the distal end of the air intake port being a portion of the air intake port farthest from the central axis of the outside air introduction port.

2. The battery pack according to claim 1, wherein
the outside air introduction port is exposed when viewed from the air intake port.

3. The battery pack according to claim 1, wherein
the air intake port includes a first air intake port and a second air intake port, and
the first air intake port and the second air intake port are provided in the side wall of the cover member to sandwich the outside air introduction port.

4. The battery pack according to claim 1, wherein
the eaves wall has a funnel shape that gradually approaches a central axis of the air intake port from the tip end of the eaves wall toward a base end of the eaves wall.

5. The battery pack according to claim 1, wherein
the top plate portion of the case includes a tubular portion extending upward from an edge of the outside air introduction port, and
an upper end of the tubular portion is located lower than a lower end of the air intake port.

6. The battery pack according to claim 5, wherein
the tubular portion of the case has a funnel shape that gradually approaches the central axis of the outside air introduction port from the upper end of the tubular portion toward a lower end of the tubular portion.

7. The battery pack according to claim 5, wherein
the top plate portion of the case and the side wall of the cover member form a recessed portion between the tubular portion of the case and the side wall of the cover member.

8. The battery pack according to claim 7, wherein
the top plate portion of the case or the side wall of the cover member is provided with a discharge port leading to an outside of the case from the recessed portion.

9. The battery pack according to claim 8, wherein
the air intake port includes a first air intake port and a second air intake port,
the first air intake port and the second air intake port are provided in the side wall of the cover member to sandwich the outside air introduction port in a first direction,
the discharge port includes a first discharge port and a second discharge port, and
the first discharge port and the second discharge port are provided to sandwich the outside air introduction port in a second direction orthogonal to the first direction.

10. A vehicle comprising:
the battery pack according to claim 1; and
a drive source configured to receive power supply from the battery pack, wherein
the battery pack is provided between a floor panel and a seat of the vehicle.

11. A vehicle comprising:
the battery pack according to claim 2; and
a drive source configured to receive power supply from the battery pack, wherein
the battery pack is provided between a floor panel and a seat of the vehicle.

12. A vehicle comprising:
the battery pack according to claim 3; and
a drive source configured to receive power supply from the battery pack, wherein
the battery pack is provided between a floor panel and a seat of the vehicle.

13. A vehicle comprising:
the battery pack according to claim 4; and
a drive source configured to receive power supply from the battery pack, wherein
the battery pack is provided between a floor panel and a seat of the vehicle.

14. A vehicle comprising:
the battery pack according to claim 5; and
a drive source configured to receive power supply from the battery pack, wherein
the battery pack is provided between a floor panel and a seat of the vehicle.

15. A vehicle comprising:
the battery pack according to claim 6; and
a drive source configured to receive power supply from the battery pack, wherein
the battery pack is provided between a floor panel and a seat of the vehicle.

16. A vehicle comprising:
the battery pack according to claim 7; and
a drive source configured to receive power supply from the battery pack, wherein
the battery pack is provided between a floor panel and a seat of the vehicle.

17. A vehicle comprising:
the battery pack according to claim 8; and
a drive source configured to receive power supply from the battery pack, wherein
the battery pack is provided between a floor panel and a seat of the vehicle.

18. A vehicle comprising:
the battery pack according to claim 9; and
a drive source configured to receive power supply from the battery pack, wherein
the battery pack is provided between a floor panel and a seat of the vehicle.

19. The vehicle according to claim 10, wherein
the battery pack is provided such that the opening direction of the air intake port is a width direction of the vehicle.

20. The vehicle according to claim 19, wherein
the seat is movable in a front-rear direction of the vehicle, and
in a state where the seat is disposed at a most rearward position, at least a part of the cover member of the battery pack is exposed from the seat.
